(19) United States
(12) Patent Application Publication
(10) Pub. No.: US 2013/0016044 A1
(43) Pub. Date: Jan. 17, 2013

(54) METHOD AND APPARATUS FOR SELECTING EDUCATIONAL CONTENT

(71) Applicants: Chris Nguyen, Baltimore, MD (US); Chris Hoehn-Saric, Miami, FL (US); Lee Clinton, Baltimore, MD (US)

(72) Inventors: Chris Nguyen, Baltimore, MD (US); Chris Hoehn-Saric, Miami, FL (US); Lee Clinton, Baltimore, MD (US)

(73) Assignee: LEARNING CENTER OF THE FUTURE, INC., Baltimore, MD (US)

(21) Appl. No.: 13/180,109

(22) Filed: Jul. 11, 2011

(51) Int. Cl. G09G 5/00

(52) U.S. Cl. 345/173; 345/156

(57) ABSTRACT

The learning system disclosed herein enables a performance assessment to be incorporated or integrated into instructional materials being administered to a student as part of the student's current learning prescription. As the student progresses through the instructional materials, the system collects and maintains data regarding the student's performance. When data indicate that the student is not meeting certain educational goals, the system adjusts or alters the student's learning prescription to accommodate the student's current needs.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

It is known that all students learn at their own pace and that some students advance more quickly than others. Since each individual learns at a different pace, it can be difficult to hold a student's attention. This may be because the student is progressing faster than the teacher's lesson plan, or it could be because the student is having a hard time keeping up with the material.

Teachers periodically assess their students to determine whether the assigned material has been retained by the student and/or whether the student is on track for meeting their educational goals. The results from such an assessment may be used by the teacher to update or amend a current lesson plan for the student or a student's educational goals. When the teacher wants to know how the student is doing (for the purpose of determining whether to modify a student's lesson plan), this typically requires the separate step of providing one or more assessment tests to the student. This can take time. Also, after the teacher determines that an adjustment to the student's lesson plan is needed, it takes additional time and effort for the teacher to change or update the current lesson plan.

Sometimes a student has a bad day, is going through a tough time in his or her life, or is worried about something (e.g., an upcoming test at school or his parents' divorce). This can cause the student to be distracted or can otherwise affect their coursework. It is often the case that, by the time the teacher becomes aware of the issue, valuable learning time has already been wasted.

There is a need for a learning system and method which continuously and automatically evaluates the progress of a student to enable making adjustments to a student's lesson plan, without the need for separate assessment tests. There is also a need for a method and system which selects and customizes learning content suited to the particular student.

### SUMMARY

The learning system disclosed herein enables a performance assessment to be incorporated or integrated into instructional materials being administered to a student as part of the student's learning prescription. As the student progresses through the instructional materials, the system collects and maintains data regarding the student's performance. When data indicate that the student is not meeting certain educational goals, the system adjusts or alters the student's learning prescription to accommodate the student's current needs.

In one embodiment, the system generates a student profile for a student. The student profile is utilized by the system to determine a learning prescription for that student. In one embodiment, various initial assessment activities (such as a battery of assessment or diagnostic tests, sometimes referred to herein as a “pre-test”) are administered to student to generate the student profile. The student profile contains, among other data, personal information about the student (e.g., age, gender, languages spoken, birthday, etc.), and may specify at least one learning objective and/or skill gap associated with the student. For example, the student profile may specify one or more skill gaps which need to be filled by further instruction. As further discussed below, the student profile is utilized to create the learning prescription for the student.

Instructional material (e.g., one or more educational assignments or lessons to be completed by the student) is generated for the student in accordance with the student's learning prescription. The system causes the instructional material to be delivered to the student, such as by causing the instructional material to be displayed to the student on a display device of a student computer or student workstation. The system enables the student to interact with the displayed instructional material at the student computer or workstation. For example, the system displays a math lesson including a plurality of problems to be completed by the student. The system enables the student to input answers to the problems at the student workstation. As the student progresses through the displayed instructional material, the system tracks various activities and inputs made by the student (e.g., the student's responses to the problems). As the system monitors the student's activities or progress on the displayed instructional material, the system evaluates the student's performance on the instructional material.

An assessment or test is embedded or integrated in the instructional materials. The student's performance on the integrated assessment determines whether or not an adjustment or modification to the student's prescription is required or would be beneficial to the student. In one embodiment, the instructional materials incorporate one or more assessment items which are part of the integrated assessment or test. For example, if the student is working on a set of math problems, a subset of the math problems (e.g., one or more of the math problems) form part of the integrated assessment, and the student's performance on those particular problems determines whether the student's prescription requires adjustment. In another embodiment, the integrated assessment is based on the student meeting certain criteria in association with the instructional material. For example, the integrated assessment may be based on: (i) whether a designated number of problems are answered correctly by the student; (ii) whether a designated number of problems are answered correctly by the student in a certain amount of time; (iii) whether a consecutive number of problems are answered correctly by the student; (iv) whether a designated percentage of problems are answered correctly by the student, (v) whether any other suitable criteria is met by the student in association with the lesson or a designated number of lessons, (vi) or any suitable combination of these.

In various alternative embodiments, the system performs the integrated assessment in response to a prescription review triggering event, such as: (i) at designated time intervals (e.g., every thirty minutes), (ii) after a designated number of lessons have been completed by the student (e.g., after one lesson has been completed, after six one hour lessons have been completed), (iii) upon a request by the teacher; (iv) when the system detects that the student has been idle or has not made an input for a designated amount of time (e.g., the student is struggling to get through the instructional material); or (v) upon the occurrence of any other suitable prescription review triggering event.

In one embodiment, if the results of the integrated assessment indicate that an adjustment of the student's prescription is necessary or would be beneficial to the student, the system automatically makes the adjustment to the learning prescription for that student and adapts to the new path or approach. That is, if the student's learning prescription is adjusted based on the results of the integrated assessment, the system modifies or adapts the instructional material for delivery to the student in accordance with the new or adjusted learning prescription. In this manner, the student's prescription and, thus, the materials presented to the student, may be adjusted on the fly to accommodate the student's current needs or skills. In one embodiment, the adjustment to the student's prescription is made in real time. In another embodiment, if the results of the integrated assessment indicate that an adjustment of the student's prescription is necessary or would be beneficial to the student, the system makes the adjustment to the learning prescription, but this requires teacher approval. In a further embodiment, the system notifies the teacher and enables the teacher to make the adjustment to the learning prescription.

In this manner, the disclosed system enables dynamic monitoring of the student's progress and assessment of whether a current approach being used to teach the student is effective. The assessment is integrated into instructional material the student is already working on as part of the current learning prescription or approach. By integrating or embedding the assessment in the instructional material itself, a student's learning prescription may be automatically and systematically updated, without the need to administer a separate test to the student.

Certain embodiments of the disclosed system enable customizing a student's learning experience by selecting content to present to the student that is tailored to that particular student. In one embodiment, the system selects the content to be presented to a particular student based on the student profile associated with that student. In various embodiments, the content may be selected automatically by the system, by the teacher, by the student, or by any suitable combination of these.

Different types of content and different students are each associated with respective profiles having different attributes. The system utilizes mapping rules to match certain content to a student based on those attributes. For instance, a student's profile may specify the student's age, and certain content may be appropriate for students of that age. The system matches the student with the content that is appropriate for his or her age group. For example, content to teach double digit addition to a 7^{th} grader is different than content to teach double digit addition to a 3^{rd} grader. The selection of content to be presented to a student may be academic based (e.g., based on the type of learner the student is), aesthetically based (e.g., based on the student's interests, such as favorite colors or favorite animals), or based on a combination of these. The system of the present disclosure thus enables providing tailored content to students to help them stay focused and engaged during learning sessions.

Additional features and advantages are described herein, and will be apparent from, the following Detailed Description and the figures.

### BRIEF DESCRIPTION OF THE FIGURES

FIG. 1 is a block diagram showing one example of a network communications system for implementing the system disclosed herein.

FIG. 2 is a more detailed block diagram showing one example of a computing device.

FIG. 3A is a schematic diagram of one example embodiment of the system of the present disclosure, which is designed for use with a worktable that seats a teacher and a number of students.

FIG. 3B is a FIG. 2 is a schematic diagram of another example embodiment of the system of the present disclosure, which includes a plurality of worktables, such as the worktable of FIG. 3A.

FIG. 4 is a flowchart of an example process for adjusting a student's learning prescription based on the results of an assessment which is integrated into instructional materials being presented to the student.

FIG. 5 is a flowchart of an example process for selecting content to be presented to a user based on a user profile associated with the user.

FIG. 6 shows a computer screen with a default user interface for an example educational application.

FIG. 7 illustrates one example of a customized user interface which overlays the default user interface of FIG. 6, where the customized user interface is customized for a young female student.

FIG. 8 illustrates another example of a customized user interface which overlays the default user interface of FIG. 6, where the customized user interface is customized for a young male student.

### DETAILED DESCRIPTION

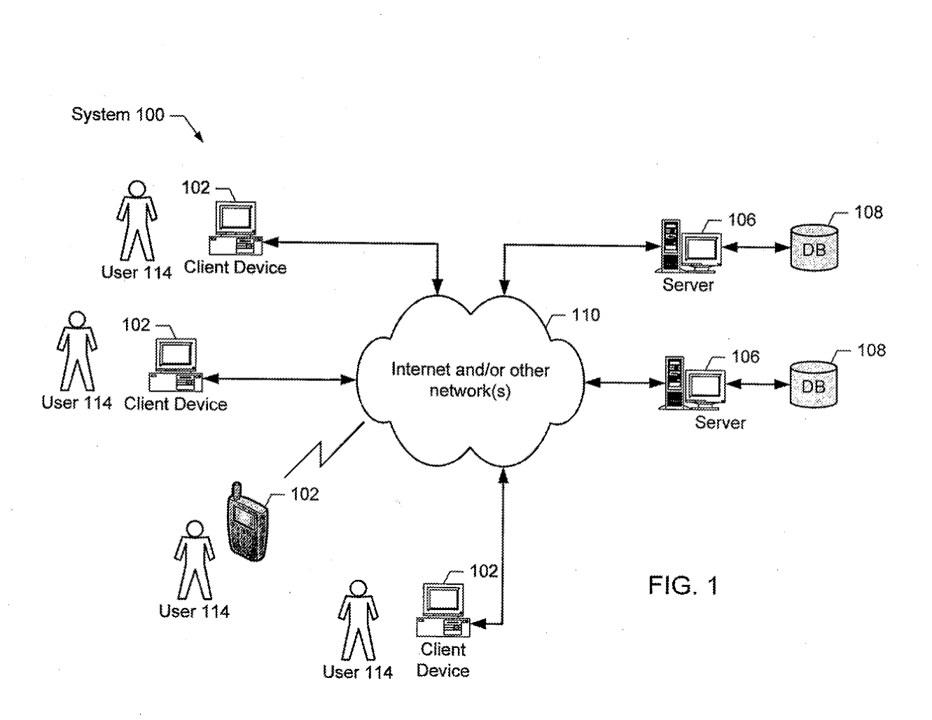

The present disclosure provides a computer based system for generating and dynamically updating or modifying a learning prescription of a student. Referring now to FIG. 1, the disclosed system may be realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The databases 108 may be connected directly to the web server 106 and/or via one or more network connections.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

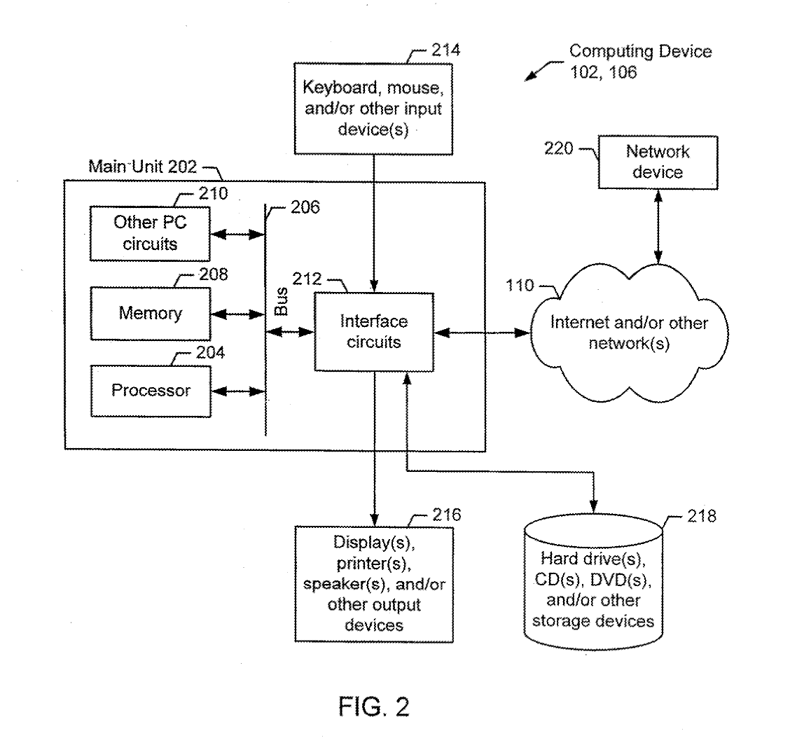

A more detailed block diagram of the electrical systems of a computing device (e.g., client device 102 and/or server 106) is illustrated in FIG. 2. Although the electrical systems of a client device 102 and a typical server 106 may be similar, the structural differences between the two types of devices are well known.

The client device 102 may include a personal computer (PC), a tablet-style computer, a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc. Stylus-sensitive displays are currently available for use with tablet computers, and such displays may be used as device 216, as discussed below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data or content used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

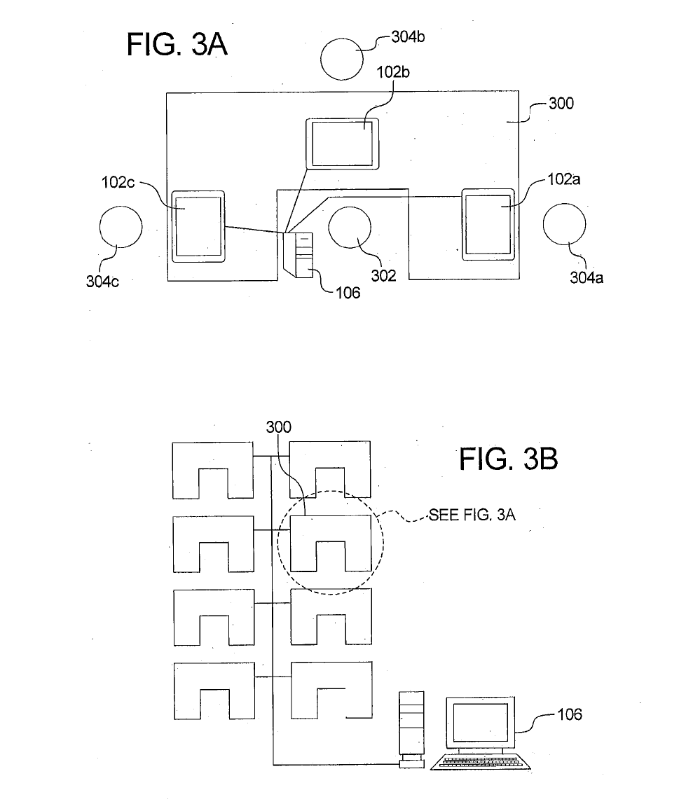

In one example, as shown schematically in FIG. 3A, the system is designed for use with a worktable 300 that seats a teacher and a plurality of students. The teacher instructs one or more students at the worktable 300. The worktable 300 has a teacher position 302 where a teacher can be seated and a plurality of student positions 304a, 304b, and 304c where students can be seated. FIG. 3A shows three student positions 304a, 304b, and 304c at the worktable 300, but any number of student positions is possible depending on the desired student/teacher ratio.

The teacher sits at the worktable 300, and each student sits at the worktable 300 at a location that is generally opposite the teacher. A computing device or student workstation 102a, 102b, and 102c (collectively 102) is located between each student and the teacher. In the illustrated example, the student workstations 102 are networked CPUs with a pen-based tablet input and display. Each pen tablet or student workstation 102 is placed on the surface of worktable 300 in front of a respective one of the student positions 304a, 304b, and 304c. In FIG. 3A, the worktable 300 is shown in the shape of a “U” with the teacher position in the middle surrounded by the student positions (and the student workstations located at the student positions). However, it should be appreciated that other suitable configurations for the worktable 300 may be employed.

In the illustrated example, system is designed to preserve student-teacher interaction, because the tablet or student workstation 102 is on the surface of the worktable 300 and is not a vertical display interfering with eye contact. Other embodiments are contemplated which further provide mechanisms by which the angle of the screen may be adjusted, or other input devices such as keyboards to supplement the pen input. It should be appreciated that, although the workstations 102 are referred to herein as “student workstations,” at various points or stages during learning sessions, the student and teacher may share the data or material being displayed on the display device of the workstation. That is, multiple users (e.g., the teacher and a student) may share the same single display device of a student workstation, as discussed in detail below.

The system architecture incorporates a server 106 networked to and capable of receiving input from the workstations 102. The server 106 is adapted to track the various activities and inputs of each student at the student workstations 102 and record student input data, either automatically through the student workstations 102, or manually as a result of teacher inputs. FIG. 3B shows another embodiment including a server 106 and multiple worktables 300, such as the worktable illustrated in FIG. 3A.

Each student workstation 102 is capable of running any one of a plurality of programs, either supplied by the network provider or over the server 106, or run from a hard disk, RAM or other storage device on the workstation itself. In other words, for example, the system software and applications software are preferably fully compatible with commercially available computer systems, such as, for example Pentium™ based personal computer systems, to allow third party commercial educational software to be easily integrated over the network. Of course, the present disclosure is not limited to any one kind of processor type, and other computer systems and processors may be employed. In another embodiment, the student workstations are merely displays and inputs, and all calculation takes place at the server level.

Suitable content or material may be displayed to each of the students through the pen tablet interface of the student's workstation 102. The delivery of such content or material is accomplished in accordance with a previously assessed student profile associated with each student, as further discussed below.

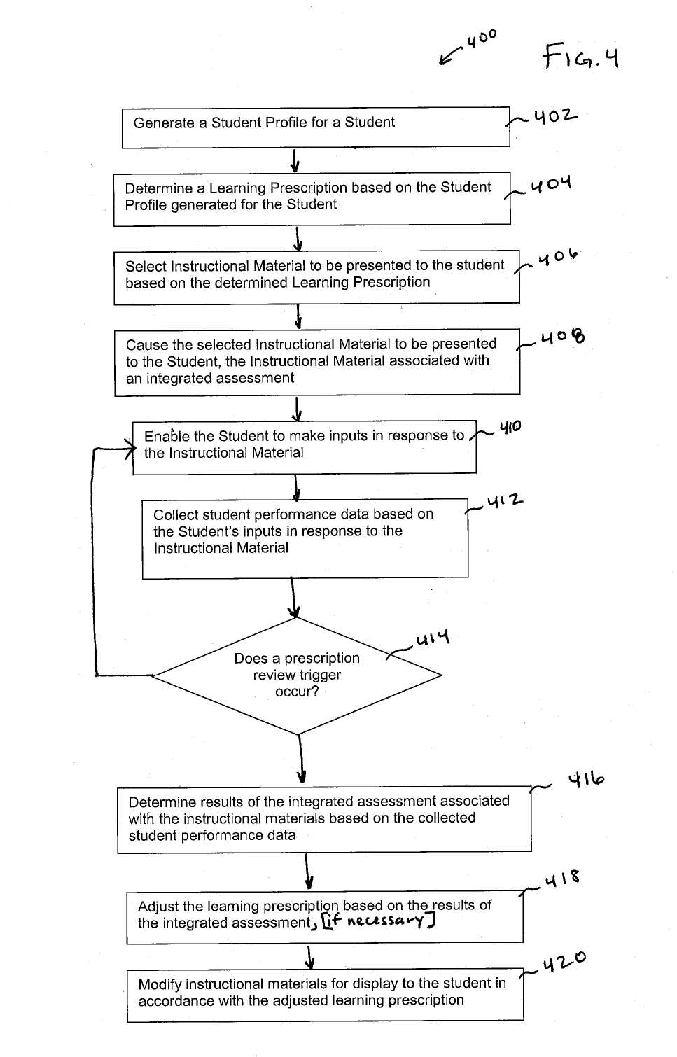

A flowchart of an example process 400 for adjusting a student's learning prescription based on the results of a performance assessment, which is integrated into instructional material delivered to the student at a networked computing device or student workstation 102, is illustrated in FIG. 4. Preferably, the process 400 is embodied in one or more software programs which is stored in one or more memories and executed by one or more processors. Although the process 400 is described with reference to the flowchart illustrated in FIG. 4, it will be appreciated that many other methods of performing the acts associated with process 400 may be used. For example, the order of many of the steps may be changed, and many of the steps described are optional. The process 400 of FIG. 4 may be executed by a system such as that illustrated in FIGS. 3A and 3B, including a server 106 and one or more computing devices or student workstations 102.

In general, the process 400 causes the system to provide performance assessment which is integrated into instructional materials being administered to a student as part of the student's current learning prescription. As the student progresses through the instructional materials, the system collects and maintains data regarding the student's performance. When data indicate that the student is not meeting certain educational goals, the system adjusts or alters the student's learning prescription to accommodate the student's current needs.

A student profile is generated for the student (block 402). The system contemplates an arrangement whereby a student enters the learning environment represented in FIGS. 3A and 3B and receives a battery of initial assessment tests, which, in a preferred system, would be an automated battery of tests for assessment and diagnostics in order to produce the student profile. The tests are generally designed to identify the ability to perform different tasks or the mastery of certain learning objectives or skills.

The initial assessment tests (or “pre-tests”) are scored and analyzed by computer to generate a student profile which is then utilized by the system of the present invention to generate a learning program suited to that student. The student profile contains, among other data, personal information or data, such as a student's age, gender, birthday, interests, hobbies, school, or geographic location. The student profile contains data regarding learning objectives or goals, and skill gaps which need to be filled by further instruction.

The initial assessment test or pre-test required to generate the student profile is preferably automated in order to avoid manual testing errors that can have significant effect on the assessment of the student's progress. Such automated testing can be executed at the workstation using the pen tablet interface of the preferred embodiment, or another appropriate interface. It is also possible for assessment and diagnostic testing to take place remotely from the worktable.

In one embodiment, initial assessment test is administered to the student from a centralized location such as a centralized computer or collection of computers (e.g., a server). Thus, the initial assessment test is capable of being distributed to a number of students via a computer network, such as an internet or an intranet. In this fashion, each student is able to access the initial assessment test using a client program (e.g., a web browser). In an example, the initial assessment test may be administered to a student online for a tablet based classroom.

A number of alternate arrangements for conducting the initial assessment test for generating a student profile are contemplated. A first arrangement employs a scannable score sheet for machine scoring. The scannable score sheet is scanned by an image scanner. The scannable score sheet is typically a “bubble sheet” for entry of answers. This technique uses an answer sheet which is keyed to an associated instruction booklet. Another alternative arrangement of the initial assessment test is a computer test arrangement in which the computer screen is used to display test questions and the answers may be entered on the screen using the electronic pen or other input device. Either in the embodiment using scannable sheet or the computer test, scores are computed automatically upon entry into the computer, and a student profile generated from the results.

Referring back to FIG. 4, a student prescription is determined or generated in accordance with the student profile (block 404). Instructional material to be delivered or presented to the student is selected based on the student prescription (block 406). In general, the teacher selects instructional material for each student in accordance with the prescription made for that student. However, in certain embodiments, the system selects (or assists in the selection of) instructional materials in accordance with the student's prescription. The instructional material is associated with an integrated assessment. As discussed in detail below, if the student's performance on the integrated assessment indicates that the student is not meeting or is exceeding certain educational goals, the system adjusts or alters the student's learning prescription to accommodate the student's current needs.

It should be appreciated that the system provides instructional materials on hand whenever they are needed, and appropriate materials can be provided to students when those students need it. As further discussed below, those materials which prove to be most successful with various students can be automatically favored by the system. The system is flexible and adaptive, and it delivers appropriate materials to suit teacher, school or center, and/or student needs. The system delivers book, worksheet, and notebook pages, as well as instructional, simulation, practice, or other software. New courses and materials can be readily incorporated into the curriculum by updating the system software without extensive operation or training changes.

The selected instructional material is delivered or presented to the student (block 408), such as by causing the instructional material or content to be displayed by the display device of a student workstation for that student.

The teacher can hold multiple learning sessions with the students seated at the worktable 300. For example, the teacher may cause instructional materials, such as a math lesson including a number of math problems, to be displayed to a first student on the workstation for that student. That first student may then answer the math problems by physically entering the answer on the screen. In the meantime, the teacher may be working with a second student on different instructional materials delivered to the workstation for the second student. When the first student has completed the lesson, the teacher can review the student's work, such as by call upping the correct answers on that student's workstation for comparison with the student's answers. The teacher may be required to supply certain identifying information to have access to the answers or an answer key. After reviewing the student's work, the teacher may provide feedback to the student. For example, if any answers are incorrect, the teacher may discuss the reason for the error with the student.

Referring back to FIG. 4, after causing the selected instructional material to be presented to the student, the student is enabled to make student inputs in response to the instructional material or content (block 410) being presented to the student. As the student progresses through the instructional material, the system tracks various inputs made by the student (e.g., the student's responses to the problems). The system evaluates the student's performance on the instructional material and records or collects student performance data based on the student's inputs in response to the instructional material (block 412). The student performance data for the instructional material is recorded or stored in the student profile for that student.

The system determines whether a prescription review trigger occurs (block 414). The prescription review trigger may occur, for example, (i) at designated time intervals (e.g., every thirty minutes), (ii) after a designated number of lessons have been completed by the student (e.g., after one lesson has been completed, after six one-hour lessons have been completed), (iii) upon a request by the teacher; (iv) when the system detects that the student has been idle or has not made an input for a designated amount of time (e.g., the student is struggling to get through the instructional material); or (v) upon the occurrence of any other suitable prescription review triggering event.

If the prescription review trigger does not occur, the system continues enabling the student to interact with the instructional material being presented to the student, such as by making inputs in response to that instructional material.

If the prescription review trigger occurs, the system determines the results of the integrated assessment associated with the instructional materials based on the student's performance data (block 416).

In one embodiment, the instructional materials are associated with or incorporate one or more assessment items. For example, if the student is working on a set of math problems, one or more of those math problems form part of the integrated assessment, and the student's performance on those particular problems determines whether the student's prescription requires adjustment. In another embodiment, the integrated assessment is based on the student meeting certain criteria in association with the instructional material. For example, the integrated assessment may be based on: (i) whether a designated number of problems are answered correctly by the student; (ii) whether a designated number of problems are answered correctly by the student in a certain amount of time; (iii) whether a consecutive number of problems are answered correctly by the student; (iv) whether a designated percentage of problems are answered correctly by the student, (v) whether any other suitable criteria is met by the student in association with the lesson or a designated number of lessons, (vi) or any suitable combination of these.

If necessary, the student's learning prescription is adjusted or modified based on the results of the integrated assessment (block 418). In one embodiment, if the results of the integrated assessment indicate that an adjustment of the student's prescription is necessary or would be beneficial to the student, the system updates or adjusts the learning prescription to better address the student's current needs. In one such embodiment, the system automatically makes the adjustment and adapts to the new path or approach. The current prescription for the student is thus evaluated and adjusted by the system on the fly based on the student's performance. In certain embodiments, the system makes the adjustment to the student's prescription in real time. In other embodiments, the adjustment is done by the system in response to approval of the teacher, wherein such approval may be obtained from the teacher in advance or after the determination is made that a prescription adjustment is necessary or would be beneficial to the student.

In one embodiment, when the assessment results indicate that an adjustment of the student's prescription is necessary, the system notifies the teacher and enables the teacher to make the adjustment to the prescription. In one embodiment, the system enables a teacher to modify the student's prescription according to teacher perception. For example, if the teacher perceives that the student is having a bad day, is worried about test, or is otherwise distracted, the system enables the teacher to adjust the student's prescription accordingly (e.g., through assignment of more appropriate content).

The instructional materials to be presented to the student are adapted or modified in accordance with the adjusted learning prescription for the student (block 420). The system selects further instructional material to be presented to the student based on the results of the integrated assessment. In some embodiments, the instructional material may be modified or adapted based on the results of the integrated assessment. The instructional material may be automatically modified or adapted to accommodate the student's weaknesses and strengths. For example, the instructional material to be displayed to the student may be adaptively tailored to focus on strengthening the student's understanding of concepts that the student has not yet fully grasped. The modified or adapted instructional material may be delivered or provided directly to the student automatically or may require teacher approval prior to delivering the material to the student.

In this manner, the disclosed system enables dynamic monitoring of the student's progress and assessment of whether or not the current approach being used to teach the student is effective. An assessment is embedded into instructional material the student is already working on as part of the current learning prescription or lesson plan. By embedding an assessment in the instructional material itself, a student's prescription may be automatically and systematically updated, without the need to administer a separate test to the student.

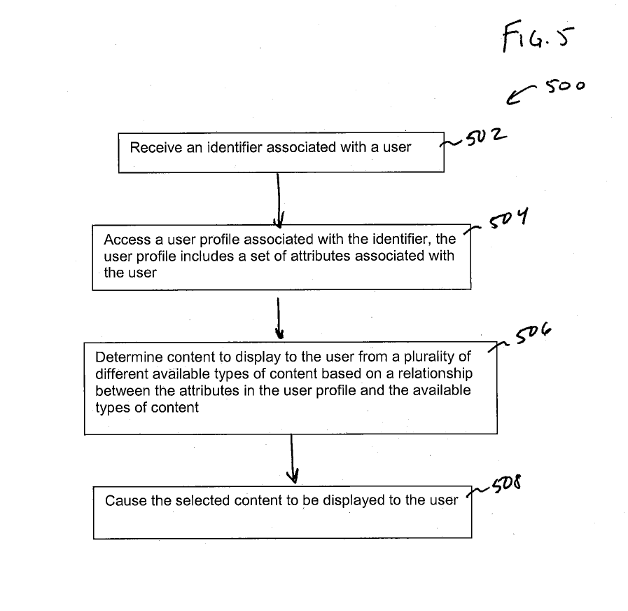

Referring now generally to FIG. 5, in one embodiment, the disclosed system dynamically adapts or modifies the manner in which content is displayed to a user, such as a student, in order to accommodate the unique learning style, skills, and preferences of that student. More particularly, the system enables customizing a student's learning experience by selecting content to present to the student that is tailored to that student.

A flowchart of an example process 500 for selecting content to display to a user, such as a student, is illustrated in FIG. 5. Preferably, the process 500 is embodied in one or more software programs which is stored in one or more memories and executed by one or more processors. Although the process 500 is described with reference to the flowchart illustrated in FIG. 5, it will be appreciated that many other methods of performing the acts associated with process 500 may be used. For example, the order of many of the steps may be changed, and many of the steps described are optional. The process 500 of FIG. 4 may be executed by a system such as that illustrated in FIGS. 3A and 3B, including a server 106 and one or more computing devices or student workstations 102.

In general, the process 500 causes the system to receive an identifier associated with a user (block 502). In one embodiment, the system enables a user to to input identifying information (e.g., a user identifier) via one or more input devices. In one example, the display device of a student computer or workstation at which a student is engaged in a learning session includes a touch-sensitive display device (e.g., a touch screen) configured to detect contact by a user's finger or a stylus. A user can make inputs via the touch screen. The system may identify a user based on inputs made by the user via the touch screen. In one example, a user has a stylus which is associated with or coded specifically to that student. When the user utilizes his or her stylus to make inputs via the touchscreen, the system associates any information or commands inputted with the owner of that particular stylus.

After receiving the identifier, the process 500 causes the system to access a user profile (e.g., a student profile for a student) associated with the identifier (block 504). The user profile includes a set of attributes associated with the user. For example, a user profile associated with a student (e.g., the student profile) may include data regarding the student's name, age, geographic location, gender, and other characteristics or attributes of the student, such as the student's interests, hobbies, learning style, skills, and skill gaps, etc.

The process 500 causes the system to determine content to display to the user from a plurality of different available types of content based on a relationship between the attributes in the user profile and the available types of content (block 506). After the system determines or selects which content to display to the student, the process 500 causes the system to display the selected content to the user (block 508).

Different types of content and different users are each associated with respective profiles having different attributes. The system utilizes mapping rules to match certain content to a user based on those attributes. For instance, a student profile may specify a student's age, and certain content may be appropriate for students of that age. The system matches the student with the content that is appropriate for his or her age group. For example, content to teach double digit addition to a 7^{th} grader is different than content to teach double digit addition to a 3^{rd} grader.

In various embodiments, the selection of content to be presented to a student may be academic based (e.g., based on the student's learning style), aesthetically based (e.g., based on the student's interests), based on the student's personal data (e.g., age, gender, geographic location), or based on any suitable combination of these. For example, selecting content based on the learning style of the student takes into account whether the student is a visual learner, an audio learner, or a text based learner. Selecting content based on a student's interests takes into account the student's personal preferences, such as the student's favorite colors, favorite animals, or favorite sports, etc. By matching content to a student based the student's attributes, the system of the present disclosure thus enables providing tailored content to the student to help that student stay focused and engaged during learning sessions.

In various embodiments, the content to be displayed to a student may be selected automatically by the system, by the teacher, by the student, or by any suitable combination of these. In one embodiment where the student can select his or her own content, the system selects one or more content choices from a plurality of available content choices based on a relationship between the attributes in the student profile and the available content. The system enables the student to make selections from the content choices and then displays the content associated with the selected content choices to the student.

In an example embodiment, the disclosed system is implemented in a learning environment where a teacher works with one or more students seated at a worktable, such as worktable 300 of FIG. 3A. Each student works at a computing device or student workstation 102 located on or supported by the worktable 300. The student workstations 102 include tablet computers, each having a pen or stylus-based tablet input and display 216. Selected instructional materials or programs may be provided to each student workstation 102 either by the network or run from a hard disk, RAM or other storage device on the tablet itself. A student workstation 102 is located in front of each student position, between that student position and the teacher position. Thus, each of the student workstations 102 has a student seated on one side of it and the teacher seated on the other side of it. This configuration enables the teacher to work with each of the students in a face-to-face manner at various stages of a learning session.

The student (or teacher) can make inputs and commands via one or more input devices. As described above, the student workstation 102 is a tablet computer having a touch-sensitive display device (e.g., a touch screen), configured to detect contact by a user's finger or a stylus. A user (e.g., a student or teacher) may have a stylus which is associated with or coded to that user. When a user utilizes his or her stylus to make inputs via the touchscreen, the computing device 102 associates any information or commands inputted with the owner of that stylus. It should be appreciated that other types of input devices, such as a mouse, trackball, a scroll wheel, a fingerprint reader, a touch pad, a sweep sensor, or the like may also be used with the tablet computer. One of more of these devices may be integrated with the tablet computer and/or exist separately.

The system detects or identifies which user is using or interacting with the student workstation at any given point in time based on the inputs being made at that workstation. For example, the system detects that Student A is interacting with the student workstation upon receiving an input made with a stylus associated with Student A. Once the system has identified the user interacting with the workstation, the system determines content to display to that user from a plurality of different available types of content based on a relationship between the attributes in the user profile and the available types of content. Further, the system determines the orientation in which to display the selected content on the display device 216, such that the selected content (which is tailored to that specific user) is displayed to that user in a proper orientation on the display device.

Preferably, content selected for a particular user is made available and/or displayed in the proper orientation for that user. For example, suppose a teacher and a student participate in a learning session during which the student and the teacher share a computer screen. When the student is operating the computer, the student can see the content selected for the student. When the teacher is operating the computer, the teacher can see content selected for the teacher.

In one embodiment, one or more user interface skins are provided for overlaying or “skinning” a default application user interface. The user interface skins may be customized to provide tailored content to students. In various embodiments, the user interface skin for a particular student may be selected automatically by the system based on the student profile associate with that student. In one such embodiment, the user interface skin is selected automatically by the system based on one or more of the student's age, gender, interests, preferences, learning style and/or any other attribute associated with the student and stored in the student profile. In other embodiments, the user interface skin for a particular student is selected by the teacher and/or the student.

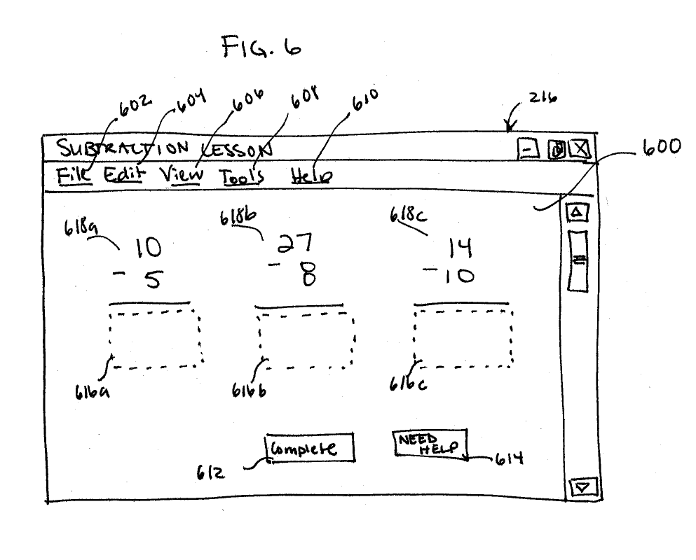

FIG. 6 illustrates an example computer screen showing a default user interface 600 for an educational application. The default user interface 600 has a variety of controls or functions, such as the file button 602, the edit button 604, the view button 606, the tools button 608, and the help button 610, for use in connection with an educational lesson provided by the underlying educational application. Additional functions include the complete button 612 and the need help button 614. In the illustrated example, the educational lesson is a subtraction lesson having three subtraction problems 618a, 618b, and 618c. In order to keep a student engaged in the underlying content (in this case, the subtraction lesson), it is desirable to display the content in a manner that is aligned with one or more of the student's age, gender, interests, preferences, learning style and/or any other attribute or characteristic of the student.

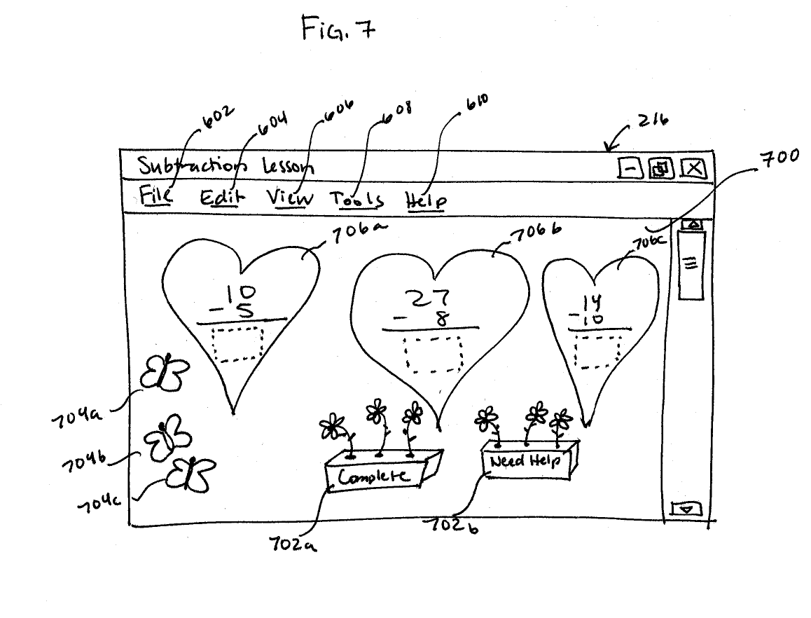

In FIG. 7, a computer screen is illustrated, which shows a customized user interface skin 700 overlaying the default user interface 600 shown in FIG. 6. In this example, the customized user interface skin 700 is for a young female student. The customized user interface skin 700 is shown overlaying the standard user interface 600 illustrated in FIG. 6. As illustrated in FIG. 7, the functionality of the default user interface 600, such as the buttons 602, 604, 606, 608, 610, 612, and 614, and the problems of the lesson 618a, 618b, and 681c are still displayed to the student, but the customized user interface skin 700 displays these elements in a manner that is appropriate and engaging for the female student's age and gender. More particularly, in the illustrated example, the standard complete button 612 and the standard need help button 614 from the default user interface 600 have been replaced with flower pot icons 702a and 702b, which are more appealing to the young female student. Additionally, graphics such as butterflies 704a, 704b, and 704c and hearts 706a, 706b, and 706c have been added.

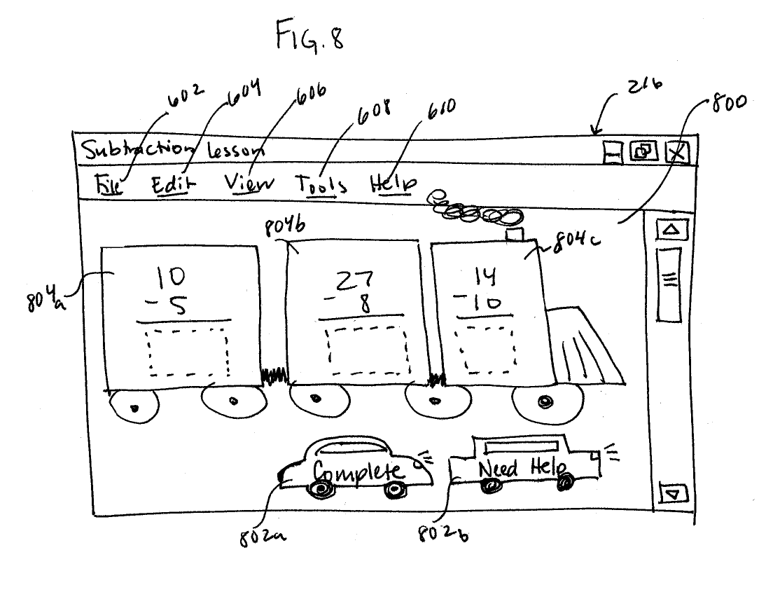

FIG. 8 illustrates another example of a customized user interface skin 800 for overlaying the default user interface 600 illustrated in FIG. 6. The example user interface skin 800 is for a young male student. Similar to the example of FIG. 7, while the customized user interface skin 800 overlays the default user interface 600, the underlying functionality of the educational application remains available to the user. In this example, the standard complete button 612 and the standard need help button 614 from the default user interface 600 have been replaced with care icons 802a and 802b, which are more appealing to the young male student. Additionally, graphics such as train cars 804a, 804b, and 804c have been added.

It should be appreciated that different customized user interface skins may be available to different users. A customized user interface skin may be generated with one or more attributes that affect its appearance based on the attributes of a given user. In certain embodiments, students can earn user interface skins, such as by meeting certain educational goals in connection with one or more lessons or learning sessions. User interface skinning options may be available for purchase using tokens earned by a student for meeting certain criteria in association with learning activities (e.g., obtaining a designated score on a lesson). In some embodiments, the system enables a student to further customize user interface skins. For example, system may enable a student to customize an already customized user interface skin to provide additional content. In certain embodiments, the student may be required to earn the opportunity to further customize user interface skins, such as by meeting certain educational goals in connection with one or more lessons or learning sessions.

While the present invention has been illustrated by a number of preferred embodiments, one of ordinary skill in the art will recognize that deletions, additions, modifications and improvements can be made while remaining within the scope and spirit of the appended claims.

The invention is claimed as follows:

1. A method for displaying content to a user on a display device, said method comprising:
(a) receiving an input identifying the user;
(b) accessing a user profile associated with the received input wherein the user profile includes a set of user attributes associated with the user, the set of user attributes including a learning style associated with the user, the learning style being determined by a teacher and an electronically intergrated assessment test;
(c) electronically determining content to display to the user from a plurality of different available types of content based on a relationship between the attributes and the available types of content; and
(d) causing the display device to display the selected content to the user.

2. The method of claim 1, wherein the display device includes a touch screen.

3. The method of claim 2, wherein receiving the input identifying the user includes receiving the input via the touch screen.

4. The method of claim 3, wherein the input identifying the user includes a user identification code.

5. The method of claim 3, wherein the input identifying the user includes an input from a coded stylus.

6. The method of claim 1, wherein the set of user attributes associated with the user includes at least one of: a learning style, an age, a gender, an interest, a skill, a preference, a language, a geographic location.

7. The method of claim 1, wherein determining the content to display to the user includes: (i) providing one or more content choices to the user from a plurality of available content choices based on the relationship between the user attributes and the available types of content, (ii) enabling the user to make at least one selection from the determined content choices, and (iii) receiving the at least one selection from the user; and (iv) determining the content associated with the selected content choice.

8. The method of claim 1, wherein each of the plurality of different available types of content is associated with at least one of a plurality of different content attributes.

9. The method of claim 8, wherein determining the content to display to the user is based on matching at least one user attribute with at least one content attribute.

10. An apparatus for selecting content to be displayed to a user comprising:
a processor;
an input device operatively coupled to the processor;
a display device operatively coupled to the processor; and
a memory device operatively coupled to the processor, the memory device storing instructions to cause the apparatus to:
(a) receive an input identifying the user;
(b) access a user profile associated with the received input wherein the user profile includes a set of user attributes associated with the user, the set of user attributes including a learning style associated with the user, the learning style being determined by a teacher and an electronically intergrated assessment test;
(c) determine content to display to the user from a plurality of different available types of content based on a relationship between the attributes and the available types of content; and
(d) display the selected content to the user.

11. The apparatus of claim 1, wherein the display device includes a touch screen.

12. The apparatus of claim 2, wherein the instructions cause the apparatus to receive the input identifying the user by receiving the input via the touch screen.

13. The apparatus of claim 3, wherein the input identifying the user includes a user identification code.

14. The apparatus of claim 3, wherein the input identifying the user includes an input from a coded stylus.

15. The apparatus of claim 1, wherein the set of user attributes associated with the user includes at least one of: a learning style, an age, a gender, an interest, a skill, a preference, a language, a geographic location.

16. The apparatus of claim 1, wherein the instructions cause the apparatus to determine the content to display to the user by: (i) providing one or more content choices to the user from a plurality of available content choices based on the relationship between the user attributes and the available types of content, (ii) enabling the user to make at least one selection from the determined content choices, and (iii) receiving the at least one selection from the user; and (iv) determining the content associated with the selected content choice.

17. The apparatus of claim 1, wherein each of the plurality of different available types of content is associated with at least one of a plurality of different content attributes.

18. The apparatus of claim 8, wherein the instructions cause the apparatus to determine the content to display to the user based on matching at least one user attribute with at least one content attribute.
